(19) United States
(12) Patent Application Publication
(10) Pub. No.: US 2006/0074175 A1
(43) Pub. Date: Apr. 6, 2006

(54) Process for forming shaped articles from polyacetal and polyacetal/non-melt processable polymer blends

(76) Inventors: Paul J. Kane, Bloomfield Hills, MI (US); Ramabhadra Ratnagiri, Wilmington, DE (US); Edmund Arthur Flexman, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/236,157

(22) Filed: Sep. 27, 2005

Related U.S. Application Data
(60) Provisional application No. 60/615,037, filed on Oct. 1, 2004.

(51) Int. Cl. C09B 67/00

(52) U.S. Cl. 524/502

(57) ABSTRACT

Process for preparing shaped articles from a powder comprising high molecular weight polyacetal and, optionally, non-melt processable polymer. Sintering the powder under heat and pressure in a batch or continuous process forms the articles.

### CROSS-REFERENCE TO RELATED APPLICATION

This application claims the benefit of U.S. Provisional Application No. 60/615,037, filed Oct. 1, 2004.

### FIELD OF THE INVENTION

The present invention relates to a method of forming shaped articles form polyacetal. More particularly, the present invention relates to a process for preparing articles from a powder comprising high molecular weight polyacetal and, optionally, non-melt processable polymer such as ultrahigh molecular weight polyethylene. The articles are formed by sintering the powder under heat and pressure.

### BACKGROUND

Many applications require that parts made from polymeric materials be in motion with respect to other parts they are in physical contact with. In such cases, it is desired that the polymeric materials have good wear resistance to avoid erosion of the surface of the parts at the point of contact. An example of such an application is a conveyor belt system where there is continuous contact between the conveyor elements and the structure supporting the elements while the conveyor is operating.

Polyacetals (also known as polyoxymethylene) are known to have excellent tribology and good physical properties. Certain physical properties of polyacetals, such as impact strength and elongation strength increase with increasing molecular weight. The increased impact strength and elongation strength of high molecular weight polyacetals are desirable for many applications. However, as polyacetals increase in molecular weight, they become harder to process using conventional melt processing techniques such as injection molding or extrusion.

Ultrahigh molecular weight polyethylene (UHMWPE) is also often used in applications requiring good wear resistance. UHMWPE has excellent resistance to abrasive wear, very high impact toughness, a low coefficient of friction, and good chemical resistance. The excellent wear resistance of UHMWPE is believed to result from a film transfer mechanism that transfers material onto the counter surface, resulting in the formation of a coherent film on the counter surface that inhibits wear. Such a film transfer mechanism does not play a significant role in the wear resistance of polyacetals, in contrast, and the wear surfaces of polyacetals tend to become gouged with extended use. However, the low melting point of UHMWPE restricts its use to applications requiring low temperatures and low-speed contact. Its useful upper temperature limit is believed to be about 75° C., whereas polyacetal can be used at temperatures above 100° C. Furthermore, the very high molecular weights of UHMWPE preclude the use of conventional melt-processing techniques (e.g. injection molding, melt extrusion, etc.) for forming articles. Thus it would be desirable to be able to obtain a method of forming articles from high molecular weight polyacetals, optionally blended with UHMWPE, that does not require melt processing. Such articles would be of particular interest for wear-resistant applications.

The following disclosures may be relevant to various aspects of the present invention and may be briefly summarized as follows:

GB 1026143 discloses polyacetals that were compression molded. FR 1546427 discloses polyacetals with number average molecular weights between 44,900 and 104,000.

### SUMMARY

Briefly stated, and in accordance with one aspect of the present invention, there is provided a process for forming an article comprising applying heat and pressure to a powdered material comprising polyacetal having a melt flow rate of less than or equal to about 0.2 g/10 min, causing the powdered material to become sintered, wherein said melt flow rate is determined using ISO Method 1133 measured at 190° C. under a 2.16 kg load.

### DETAILED DESCRIPTION

The high molecular weight polyacetal used in the process of the present invention can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/ formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy. The polyacetal will preferably be linear or have minimal chain-branching.

The high molecular weight polyacetal used in the process of the present invention will have a melt flow rate of about 0.2 g/10 min or less or preferably about 0.15 g/10 min or less, or more preferably about 0.1 g/10 min or less, as measured at 190° C. under a 2.16 kg load, following ISO method 1133. The high molecular weight polyacetal will preferably have a number average molecular weight of at least about 100,000, or more preferably at least about 110,000, or yet more preferably of at least about 150,000. The number average molecular weight will still more preferably be in the range of about 100,000 to about 300,000. Number average molecular weight is determined by gel permeation chromatography using a light scattering detector.

The high molecular weight polyacetal may be prepared using any conventional method. It will be apparent to those skilled in the art that it will be necessary to ensure that the monomers and solvents used in the preparation of the polyacetal be of sufficient purity to minimize the likelihood of chain-transfer reactions that would prevent the desired high molecular weights from being obtained during the polymerization. This will often require that the concentration of chain-transfer agents such as water and/or alcohols be kept to a minimum. See, for example, K. J. Persak and L. M. Blair, “Acetal Resins,” Kirk-Othmer Encyclopedia of Chemical Technology, 3^{rd} Edition, Vol. 1, Wiley, N.Y., 1978, pp. 112-123.

By the term “non-melt processable polymer” as used herein is meant at least one semicrystalline or crystalline non-polyacetal polymer that either has no defined melting point or has a melt viscosity of at least 10,000 Pa.s measured at a temperature that is 5° C. above the melting point of the polymer and a shear rate of 100 s⁻¹. Preferably the non-melt processable polymer has a melt viscosity of at least 20,000 Pa.s and more preferably the non-melt processable polymer has a melt viscosity of at least 100,000 Pa.s measured at a temperature that is 5° C. above the melting point of the polymer and a shear rate of 100 s⁻¹. Examples of suitable non-melt processable polymers include ultrahigh molecular weight polyethylene, fluoropolymers such as poly(tetrafluoroethylene), polyimides, and silicone oils.

Ultrahigh molecular weight polyethylene is a particularly preferred non-melt processable polymer and is polyethylene with a number average molecular weight that is at least about 3×10⁶. Ultrahigh molecular weight polyethylenes are defined by ASTM D 4020-01a to be those linear polymers of ethylene that have a relative viscosity of 1.44 or greater, as measured at 0.02 g/ml in decalin at 135° C. The nominal viscosity molecular weight defined by the above method is at least 3.12×10⁶ g/mol.

In the process of the present invention, a powder comprising high molecular weight polyacetal is formed into an article or shaped article by applying heat and pressure, causing the powder to become sintered. The powder may comprise polyacetal that has optionally been dry blended with about 1 to about 25 weight percent of non-melt processable polymer. The powder preferably has a maximum particle diameter of no more than about 1 mm. The powder may also optionally comprise additional additives such as lubricants, processing aids, stabilizers (such as thermal stabilizers, oxidative stabilizers, ultraviolet light stabilizers), colorants, nucleating agents, compatibilizers, and mineral fillers.

The process of the present invention may be continuous or a batch process. In the process,.a charge of powder is added to an apparatus where it is sintered. During sintering, adequate heat is supplied to bring the powder to a temperature at or above the melting point of the polyacetal and sufficient pressure is exerted upon the powder for a long enough duration to cause elimination of particle boundaries and voids within the charge and to cause welding between adjacent charges when multiple sequential charges are added, particularly in a continuous process. The temperature in the apparatus will preferably be in the range of about 170 to about 210° C., or more preferably about 170 to about 190° C. After addition of the powder to the apparatus, but prior to sintering, pressure may optionally be applied to the powder in the presence or absence of externally applied heat to compact the powder and remove trapped air.

In one embodiment of the process, the articles are formed by a continuous process such as ram extrusion. In a ram extrusion process, charges of powder are continuously fed to a heated chamber that contains a reciprocating ram. Under the pressure exerted by the ram, the powder is successively compacted, sintered, and extruded though a shaped die or other orifice in the form the desired article. The die may have any suitable cross-sectional geometry. The article may also be extruded in the form of a sheet.

In another embodiment of the process, the articles are formed by a batch process such as compression molding. In a compression molding process, a charge of the powder is placed in a mold, which is subsequently closed and held under pressure for a sufficient period of time to cause the powder to become sintered in the desired shape. The resulting article is then ejected from the mold.

When other components, such as non-melt processable polymers, are dry blended with the polyacetal, the additional components are preferably substantially uniformly dispersed within the polyacetal. There is preferably little or no mixing of the components within the powder during the process of the present invention and the distribution of the components in the powder as pressure and heat is introduced during the sintering step can be substantially preserved in the resulting article. This offers an advantage over melt processes, in which fully or partially incompatible components can segregate in the melt, resulting in the formation of articles that do not have a substantially uniform or other desired distribution of components. Typical melt processes, such as injection molding require a melt viscosity of about 500 Pa.s or less at a shear rate of 100 s⁻¹ at the temperature used. Materials having zero-shear-rate viscosities of about 50,000 Pa.s or higher typically do not flow sufficiently for use in melt processes such as extrusion or injection molding.

The articles formed by the process of the present invention may be in the form of but not limited to rods; sheets; strips; channels; tubes; and conveyor system components such as wear strips, guard rails, rollers, balls, gears and conveyor belt parts.

It is therefore, apparent that there has been provided in accordance with the present invention, a process for forming articles from polyacetal and polyacetal/non-melt processable polymer that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

### EXAMPLE

Cylindrical rods were prepared from each material shown in Table 1. An initial total charge of about 12 g of each of the materials, in powder form with a maximum particle diameter of about 300 micrometers, was separately fed into a steel cylindrical barrel 1 cm in diameter and 12 cm in length and having a plugged end. The temperature of the cylinder was maintained at about 120° C. Successive ca. 2 g charges of material were fed to the cylinder and compacted under 2000 N of force. When the entire barrel was filled with powder, the temperature was raised to 180° C. while maintaining a constant force of 4000 N on the contents. When the temperature reached 180° C., the sample was held under 4000 N of force for 10 minutes to fuse the powder and form the rod. At the end of this time, heating was discontinued and the barrel was allowed to cool by convection to 120° C. over the course of about 30 minutes. The plugged end of the cylindrical barrel was then opened and the rod formed by fusing the powder was pushed out at a constant rate.

Sections of the rod were cut into cuboids of dimensions 0.25″×0.25″×0.4″ (6.35 mm×6.35 mm×10.16 mm). The cuboids were mounted onto a vertical fixture and rotated against a sheet of 600 grit abrasive paper (sandpaper having silicon carbide particles with a median particle size of 25.75 micrometers). The load pressing the cuboids against the paper and the relative angular velocity of the vertical fixture could be independently varied, allowing for independent variation of the normal pressure and linear velocity at the contact face between the test samples and the abrasive paper. The pressures and relative angular velocities used are given in Tables 2 and 3 under the headings of “pressure” and “relative velocity”, respectively. The test was continued until a measurable loss in weight of the sample was observed. The results are given in Tables 2 and 3.

TABLE 1

| | | Comparative | | |
|---|---|---|---|---|
| | Example 1 | Example 1 | Example 2 | Example 3 |
| High molecular | 100 | — | 90 | 95 |
| weight polyacetal | | | | |
| Ultrahigh molecular | — | 100 | 10 | 5 |
| weight polyethylene | | | | |

Ingredient quantities are given in weight percent relative to the total weight of the composition. The high molecular weight polyacetal had a melt flow rate of 0.13 g/10 min, determined using ISO Method 1133 measured at 190° C. under a 2.16 kg load.

The ultrahigh molecular weight polyethylene (UHMWPE) is Mipelon XM220 (available from Mitsui Chemicals), which has a number average molecular weight of 2.2×10⁶ g/mol.

TABLE 2
Low Velocity Abrasive Wear Testing

| | | Relative | Sample | Test |
|---|---|---|---|---|
| Sample | Pressure | Velocity | Wear | Duration |
| Composition | (psi) | (feet/min) | (μg/min) | (hr) |
| Example 1 | 48 | 63 | 23.54 | 13.1 |
| Comparative | 48 | 63 | 56.24 | 3.9 |
| Example 1 | | | | |
| Example 2 | 48 | 63 | 0.4 | 38.7 |
| Example 3 | 48 | 63 | 1.46 | 49.9 |

TABLE 3
High Velocity Abrasive Wear Testing

| | | Relative | Sample | Test |
|---|---|---|---|---|
| Sample | Pressure | Velocity | Wear | Duration |
| Composition | (psi) | (feet/min) | (μg/min) | (hr) |
| Example 1 | 15 | 200 | 27.29 | 4.3 |
| Comparative | 15 | 200 | 46.5 | 4.1 |
| Example 1 | | | | |
| Example 2 | 15 | 200 | 1.05 | 21.2 |
| Example 3 | 15 | 200 | 8.49 | 21.2 |

A comparison between Example 1 and Comparative Example 1 demonstrates that high molecular weight polyacetal has improved resistance to abrasive wear over UHMWPE. A comparison of Example 1 and Comparative Example 1 with Examples 1 and 2 demonstrates that the combination of high molecular weight polyacetal with UHMWPE leads to materials having improved resistance to abrasive wear relative to either of high molecular weight polyacetal or UHMWPE alone.

It is claimed:

1. A process for forming an article comprising applying heat and pressure to a powdered material comprising polyacetal having a melt flow rate of less than or equal to about 0.2 g/10 min, causing the powdered material to become sintered, wherein said melt flow rate is determined using ISO Method 1133 measured at 190° C. under a 2.16 kg load.

2. The process of claim 1, further comprising the step of applying heat and/or pressure to the powdered material prior to sintering at a temperature at or above the melting point of the polyacetal.

3. The process of claim 1 or 2 wherein the powdered material further comprises at least one non-melt processable polymer.

4. The process of claim 3 wherein the powdered material comprises about 75 to about 99 weight percent polyacetal and about 1 to about 25 weight percent non-melt processable polymer.

5. The process of claim 3 or 4 wherein the non-melt processable polymer is substantially homogeneously dispersed in the polyacetal.

6. The process of claim 3 wherein the non-melt processable polymer is ultrahigh molecular weight polyethylene.

7. The process of claim 3 wherein the non-melt processable polymer is selected from the group consisting of polyimides, fluoropolymers, and silicone oils.

8. The process of claim 1 wherein the polyacetal is linear.

9. The process of claim 1 wherein the powdered material further comprises a lubricant.

10. The process of claim 1 wherein the powder further comprises one or more of processing aids, stabilizers, colorants, nucleating agents, compatibilizers, and mineral fillers.

11. The process of claim 1 wherein the polyacetal has a melt flow rate of not more than about 0.15 g/10 min, as measured at 190° C. under a 2.16 kg load following ISO Method 1133.

12. The process of claim 1 wherein the polyacetal has a melt flow rate of not more than about 0.1 g/10 min, as measured at 190° C. under a 2.16 kg load following ISO Method 1133.

13. The process of claim 1 wherein the polyacetal has a number average molecular weight of at least about 100,000.

14. The process of claim 1 wherein the polyacetal has a number average molecular weight of at least about 110,000.

15. The process of claim 1 wherein the polyacetal has a number average molecular weight of at least about 150,000.

16. The process of claim 1 wherein the polyacetal has a number average molecular weight in the range of about 100,000 to about 300,000.

17. The process of claim 1 wherein the sintered powdered material is extruded through a die.

18. The process of claim 15 wherein the sintered powdered material is continuously extruded.

19. The process of claim 1 wherein the powdered material is sintered in a mold.

20. An article made from the process of claim 1.

21. The article of claim 20 in the form of an extruded rod, sheet, strip, or tube.

22. The article of claim 20 in the form of a conveyor system component.

23. The conveyor system component in the form of a wear strip, guard rail, roller, ball, gear, or conveyor belt part.

23. The article of claim 20 in the form of a roller or ball.
